(19) United States
(12) Patent Application Publication
(10) Pub. No.: US 2010/0237803 A1
(43) Pub. Date: Sep. 23, 2010

(54) Dimmable color selectable light emitting diodes

(76) Inventors: Jeffrey B. Wolf, Carlsbad, CA (US); Jason Vogel, Simi Valley, CA (US)

Correspondence Address: Kirk Hermann, 150 Cerro Vista Way, Anaheim, CA, 92807, US

(21) Appl. No.: 12/383,438

(22) Filed: Mar. 23, 2009

(51) Int. Cl. H05B 41/36

(52) U.S. Cl. 315/297; 315/294

(57) ABSTRACT

A dimmable color selectable light emitting diode (LED) lighting system, comprising: a plurality of light sources including at least one LED and being configured to communicate with one another over a network including at least one power line; and a controller configured to communicate with the plurality of light sources over the network to control the intensity and color of light displayed by each of the plurality of light sources.

### TECHNICAL FIELD

The present invention relates to a method and system for dimming light emitting diodes (LEDs), and more particularly, the present invention relates to a method and system for selectively dimming and adjusting the color temperature of color LEDs.

### BACKGROUND

The current trend in lighting is toward more controllable and more energy efficient lighting solutions. In order to satisfy such requirements, light emitting diodes (LEDs) have begun to replace incandescent, fluorescent and halogen lights.

However, there is a desire to have individual LEDs be controlled and synchronized to produce lighting of a certain intensity, warmth and color.

In addition, there is a desire to install and control LEDs through the use of a location's existing wiring without the necessity of major rewiring or having to install additional hardware and/or software.

The above information disclosed in this Background section is only for enhancement of understanding of the background of the invention and therefore it may contain information that does not form the prior art that is already known in this country to a person of ordinary skill in the art.

### SUMMARY OF THE INVENTION

In certain embodiments of the present invention, a dimmable color selectable light emitting diode (LED) lighting system, includes: a plurality of light sources including at least one LED and being configured to communicate with one another over a network including at least one power line; and a controller configured to communicate with the plurality of light sources over the network to control the intensity and color of light displayed by each of the plurality of light sources.

In certain embodiments of the present invention, a light source includes at least one LED, wherein the light source is configured to communicate over a network including at least one power line with at least one other light source including at least one LED to coordinate the control of the intensity and color of light displayed by the light sources.

In certain embodiments of the present invention, a lighting system, includes: a plurality of lighting means in which one of the lighting means includes at least one LED; means for coordinating the intensity and color of light emanating from the plurality of lighting means including at least one power line; and a controlling means configured to influence the intensity and color of light emanating from the plurality of lighting means.

These and other features, aspects and advantages of the present invention will become better understood with reference to the following drawings, description and claims.

### BRIEF DESCRIPTION OF THE DRAWINGS

FIG. 1 illustrates a dimmable color selectable light emitting diode (LED) lighting system according to one embodiment of the present invention;

FIG. 2 illustrates a topology of a dimmable color selectable light emitting diode (LED) lighting system according to one embodiment of the present invention;

FIG. 3 illustrates a cross-sectional view of a light source according to one embodiment of the present invention;

FIG. 4 is a table of various light sources' sizes, LED count, light intensity output, color description, color temperature and power consumption according to certain embodiments of the present invention;

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

### DETAILED DESCRIPTION OF THE INVENTION

The following detailed description of example embodiments of the invention is not to be taken in a limiting sense, but is made merely for the purpose of illustrating the general principles of the invention, since the scope of the invention is best defined by the appended claims.

Broadly speaking, the present invention generally provides a light source including at least one LED configured to be controlled using a network including at least one power line.

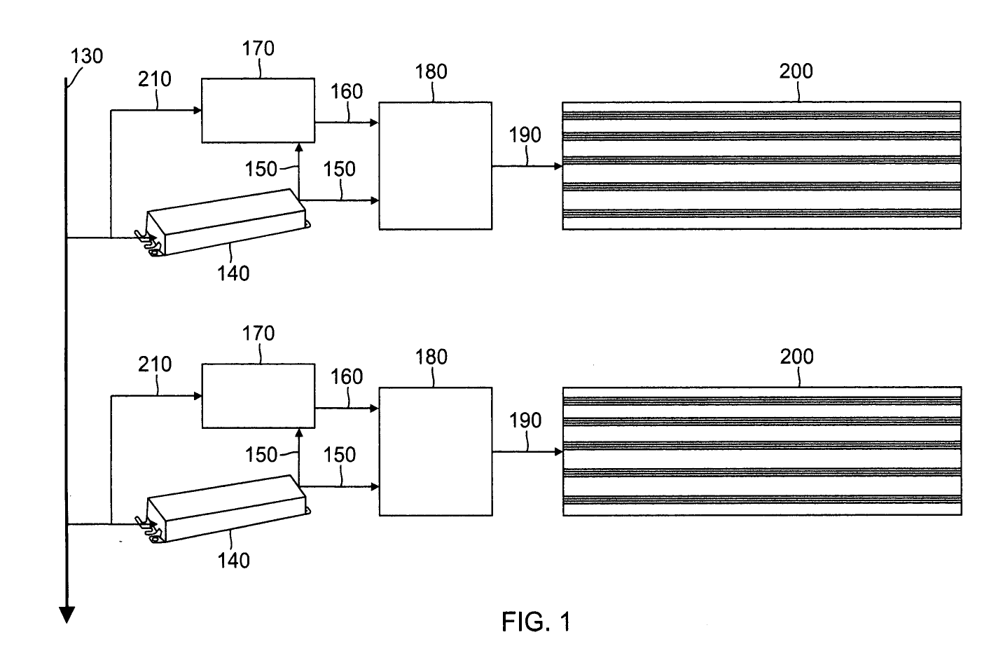

Referring now to the figures, FIG. 1 shows multiple LED lighting systems. Each of these LED lighting systems includes a network including a power line 130 coupled to a connection for transmitting color and brightness commands 210 to a processor 170, a red/green/blue (color) controller 180, color and dimming commands sent from the network processor to the red/green/blue (color controller) 160, a light source including LEDs 200, pulse width modulated DC power supplied to the light source 190, a DC power supply 140 receiving power from the network including a power line 130, DC power wiring 150 connecting the DC power supply 140 to both a network processor 170 and a red/green/blue (color) controller. In certain embodiments the network including a power line 130 is a local area network (LAN), a wide area network (WAN), a wireless network or any other type of network known in the art. In certain embodiments of the present invention connection for transmitting color and brightness commands 210 is an electrical connection, an optical connection, a magnetic connection, a wireless connection or any other type of connection known in the art.

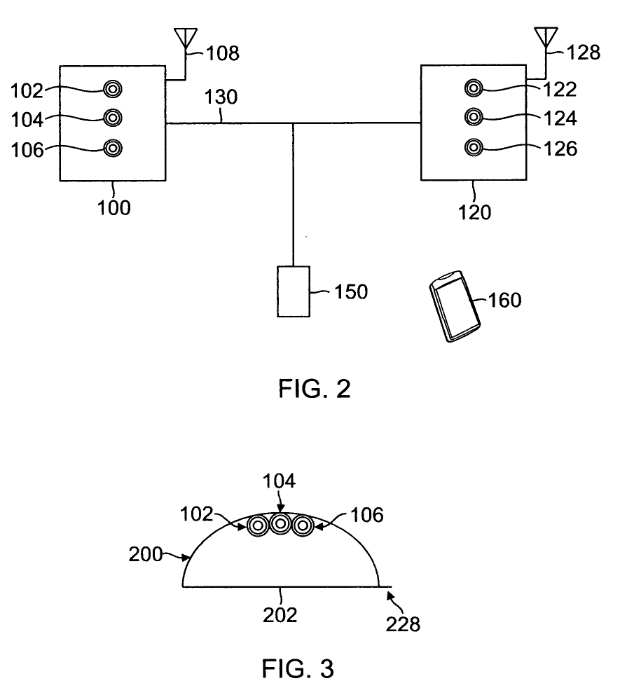

FIG. 2 shows a topology of a dimmable color selectable light emitting diode (LED) lighting system according to certain embodiments of the present invention. FIG. 2 includes light sources 100 and 120 including LEDs 102, 104, 106, 122, 124 and 126, an optional antenna 108 and 128, a network including a power line 130, a switch 150 and a remote controller 160. In certain embodiments the network including a power line 130 is a local area network (LAN), a wide area network (WAN), a wireless network or any other type of network known in the art. In certain embodiments of the present invention the LED lighting system includes a motion or sound detector that can allow for example sequential light sources to turn-on as a person comes within close proximity.

In certain embodiments of the present invention the color of the individual LEDs 102, 104, 106, 122, 124 and 126 can be, white, red, green, blue or any other color or combination of colors. One well known manufacturer of LEDs is Cree, Inc. of Durham, N.C.

In certain embodiments of the present invention light sources 100 and 120 include a controller 140 for adjusting the brightness and color of the light emanating from the LEDs 102, 104, 106, 122, 124 and 126, and a communication interface to facilitate communication between the light sources 100 and 120 and the controller 140 over a network including at least one power line 130. In certain embodiments of the present invention the light sources are configured to communicate with one another and with a controller over a network including at least one power line in a fully meshed peer-to-peer relationship repeating signals received to reduce the possibility of any one light source being out of sync with the others. In certain embodiments of the present invention the light sources include light sensors to measure the intensity and color of light being produced. In certain embodiments of the present invention each light source includes a unit address which may include an internet protocol (IP) address. In certain embodiments of the present invention each light source is configured to be able to send a message to a controller such as an alert as to its condition for example when individual LEDs are nonoperational so the controller can adjust the level of light emanating from that light source or other light sources to compensate for the condition.

In certain embodiments of the present invention the network including at least one power line 130 operates using ac power-lines based on a protocol such as X-10 standard or universal power line bus (UPB) standard. In certain embodiments of the present invention the network including at least one power line 130 operates based on a dual mesh topology utilizing ac-power lines and a radio-frequency protocol such as the Insteon technology offered by SmartLabs, Inc. of Irvine, Calif.

The controller 140 is configured to communicate over the network including a power line 130 to adjust the brightness of one or more light sources. In certain embodiments of the present invention, since the controller recognizes the unit address of each light source, additional light sources can be added in proximity to existing ones and the controller will be able to communicate to them without the need of additional wiring. In certain embodiments of the present invention, the controller can control the light emanating from the light sources from 0% to 100% in configurable steps or nonlinearly such as providing a soft turn-on and turn-off of the intensity and color of the light emanating from the light sources. In certain embodiments of the invention the controller for adjusting the level of brightness of the light emanating from the light sources is separate from the controller for adjusting the color of the light emanating from the light sources. In certain embodiments of the present invention, the controller 140 can operate via pulse modulation to control the amount of energy being consumed by each light source. In certain embodiments of the present invention the light source includes red, green and blue LEDs and the controller is configured to produce any color in the visible spectrum by pulse modulating the amount of energy to each of the LEDs. In certain embodiments of the present invention, each group of colored diodes in the light source has a separate drive line along with a common return line. In certain embodiments of the present invention coupled to each light source is an individual controller for controlling the brightness and color of light emanating from the individual light source.

The switch 150 can be any type of switch known in the art, for example in certain embodiments of the present invention it can include a three-way toggle dimmer switch for adjusting the color and intensity of the light emanating from the LEDs 102, 104, 106, 122, 124 and 126. In certain embodiments of the present invention the switch is configured to communicate with the controller over the network including a power line.

In certain embodiments of the present invention the remote controller 160 is configured to communicate with the switch 150 either using a radio-frequency protocol or an infrared protocol and/or over a network including a power line. In certain embodiments of the present invention the remote controller displays information from the controller and/or light sources such as amount of energy consumed or the remaining life of the light sources' LEDs.

FIG. 3 shows a cross-sectional view of a light source according to certain embodiments of the present invention. FIG. 3 includes a housing 200, a lens 202, an attachment configured to connect to a network including a power line 228, and LEDs 102, 104 and 106. The lens 202 can consist of any type of material known in the art such as clear dual-wall polycarbonate material that has thermal insulating properties. The attachment 228 can include a power plug, a universal serial bus (USB) connector or any other type of connector known in the art. In certain embodiments of the present invention the light source 200 can include a built in power supply such as a constant-current power supply.

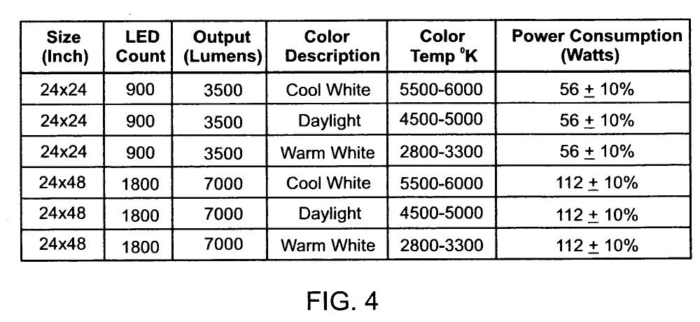

FIG. 4 is a table depicting for certain embodiments of the present invention, various light sources' sizes, LED count, light intensity output, color description, color temperature and power consumption. Size refers to the dimensions in inches of the display portion of the light source. LED count is the number of LEDs included in the light source. Output is the intensity of the light measured in lumens produced by the light source. Color description provides a short description of the color or colors produced by the light source. Color temperature is a measure of the temperature in degree Kelvin of the light produced by the light source. Power consumption is a measure in Watts of the power consumed by the light source. In some embodiments of the present invention, the light source can be a single source or a combination of more than one source.

It should be understood, of course, that the foregoing relates to exemplary embodiments of the invention and that modifications may be made without departing from the spirit and scope of the invention as set forth in the following claims.

What is claimed is:

1. A dimmable color selectable light emitting diode (LED) lighting system, comprising:
a plurality of light sources including at least one LED and being configured to communicate with one another over a network including at least one power line; and
a controller configured to communicate with the plurality of light sources over the network to control the intensity and color of light displayed by each of the plurality of light sources.

2. The system of claim 1, wherein the plurality of light sources comprises a plurality of white LEDs.

3. The system of claim 1, wherein the plurality of light sources comprises a plurality of different colored LEDs.

4. The system of claim 1, wherein the plurality of light sources are configured to be able to change nonlinearly at least one of an intensity and a color of the light sources.

5. The system of claim 1, wherein the plurality of light sources further comprise a dual-wall polycarbonate housing.

6. The system of claim 1, wherein the plurality of light sources are further configured to send a message to the controller.

7. The system of claim 1, wherein the network further comprises at least one radio frequency protocol.

8. The system of claim 1, wherein the network further comprises a remote control unit configured to communicate over the network with at least one of the plurality of light sources and the controller.

9. The system of claim 1, wherein the controller comprises a separate intensity controller to control the intensity of light emitted by the plurality of light sources and a separate color controller to control the color of light emitted by the plurality of light sources.

10. The system of claim 1, wherein the controller is programmed to affect the control of the intensity and color of light displayed by each of the plurality of light sources.

11. The system of claim 1, further comprising a motion detector whereby the intensity and color of light displayed is influenced by the motion detector.

12. A light source comprising at least one LED, wherein the light source is configured to communicate over a network including at least one power line with at least one other light source comprising at least one LED to coordinate the control the intensity and color of light displayed by the light sources.

13. The light source of claim 12, wherein the network comprises the X-10 protocol.

14. The light source of claim 12, wherein the network comprises the Insteon protocol.

15. The light source of claim 12, further comprising a network connection to a controller.

16. The light source of claim 15, wherein the controller is programmed to prioritize the control of the light sources.

17. A lighting system, comprising:
a plurality of lighting means in which one of the lighting means includes at least one LED;
means for coordinating the intensity and color of light emanating from the plurality of lighting means including at least one power line; and
a controlling means configured to influence the intensity and color of light emanating from the plurality of lighting means.

18. The light system of claim 17, further comprising a detection means to detect at least one of motion and sound.

19. The light system of claim 17, further comprising a means to program the intensity and color of the light emanating from the plurality of lighting means.

20. The light system of claim 17, wherein the controlling means comprises a remote controlling means.
